(19) United States
(12) Patent Application Publication
(10) Pub. No.: US 2012/0002171 A1
(43) Pub. Date: Jan. 5, 2012

(54) PROJECTION LENS MODULE OF PICO PROJECTOR

(76) Inventors: SHIN-GWO SHIUE, Hu Kou Township (TW); DAVID TSAI, Hu Kou Township (TW)

(21) Appl. No.: 12/828,275

(22) Filed: Jun. 30, 2010

(51) Int. Cl. G03B 21/14

(52) U.S. Cl. 353/20

(57) ABSTRACT

The projection lens module contains a number of lenses, a stop, a PBS (polarizing beam splitter), and a LCoS (liquid crystal on silicon) panel. The lenses, from outside towards inside, contains a negative first lens, a positive second lens attached to the negative first lens, a negative third lens, a positive fourth lens forming a doublet structure with the negative third lens, and a positive fifth lens. The stop is positioned between the positive second lens and the negative third lens. The PBS is positioned between the positive fifth lens and the LCoS panel, and the positive fifth lens has an area larger than that of the LCoS panel. The LCoS panel is positioned behind the PBS. The projection module is able to overcome the size issue of the projection lens module, to enhance image resolution and to reduce image distortion.

### (A) TECHNICAL FIELD OF THE INVENTION

The present invention generally relates to pico projectors, and more particular to a projection lens module for pico projectors.

### (B) DESCRIPTION OF THE PRIOR ART

A conventional desktop projector is able to provide the viewing comfort of a large screen. Yet, due to its size, weight, and power requirement, the desktop projector cannot be moved or carried around at will.

For a conventional desktop projector, its projection lens module is usually an assembly of ten or more optical components. The bulky size therefore prohibits the same design structure to be applied in the miniature body of a pico projector.

An additional drawback of the desktop projector is that, even though by adjusting the distance between the projection lens and the LCoS (light crystal on silicon) panel to achieve various degrees of magnification, the projected image usually suffers distortion (e.g., the magnification is not uniform across the entire image).

To overcome the size issue of the projection lens module, the present invention adopts a novel five-lens sequence where negative, positive, negative, positive, and positive lenses are arranged in this order. Further, to enhance image resolution and to reduce image distortion, a stop is configured at an appropriate place on the lenses and a doublet structure is adopted by the third (negative) lens and the fourth (positive) lens.

Anther feature of the present invention is that the projection lens module follows a telecentric system where the fifth (positive) lens has an area larger than that of the LCoS panel behind. The projection lens module therefore has a longer back focal length. As such, to adjust the magnification ratio by altering the distance between the lenses and the LCoS panel, the image of the LCoS panel could still be projected precisely and without distortion to the screen with accurate proportions.

### SUMMARY OF THE INVENTION

A projection lens module according to the present invention contains a number of lenses, a stop, a PBS (polarizing beam splitter), and a LCoS (liquid crystal on silicon) panel. The lenses, from outside towards inside, contains a negative first lens, a positive second lens attached to the negative first lens, a negative third lens, a positive fourth lens forming a doublet structure with the negative third lens, and a positive fifth lens.

A projection lens module according to the present invention contains a number of lenses, a stop, a PBS, and a LCoS panel. The stop is positioned between the positive second lens and the negative third lens.

A projection lens module according to the present invention contains a number of lenses, a stop, a PBS, and a LCoS panel. The PBS is positioned between the positive fifth lens and the LCoS panel, and the positive fifth lens has an area larger than that of the LCoS panel.

A projection lens module according to the present invention contains a number of lenses, a stop, a PBS, and a LCoS panel. The LCoS panel is positioned behind the PBS.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a projection lens module of a conventional projector.

FIG. 2 is a schematic diagram showing a projection lens module and its various components of a pico projector according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

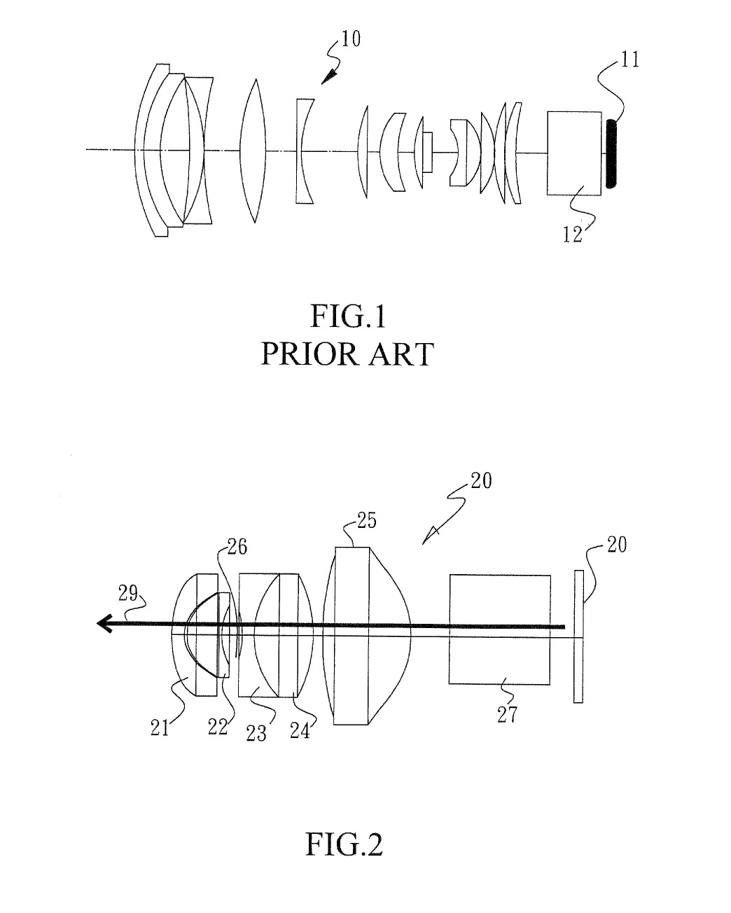

As shown in FIG. 1, a projection lens module 10 of a conventional projector contains, from outside toward inside, ten or more optical lenses, a TIR (total internal reflection) prism 12, and a DMD (digital micromirror device) 11. Incident light to the projection lens module 10 is from a source light path (not shown) beneath the TIR prism 12 and is reflected by the TIR prism 12 towards the DMD 11. The DMD 11 in turn reflect the light, together with the to-be-projected image, towards the optical lenses, which renders the projected image on a screen. As described, the conventional projection lens module 10 takes up significant space and therefore is not appropriate for a pico projector.

As shown in FIG. 2, a projection lens module 20 according to an embodiment of the present invention contains a number of lenses 21, 22, 23, 24, 25, a PBS (polarizing beam splitter) 27, and a LCoS (liquid crystal on silicon) panel 28, from outside towards inside. The lenses, in the above order, contains a negative first lens 21, a positive second lens 22, a negative third lens 23, a positive fourth lens 24, and a positive fifth lens 25. Compared to the foregoing prior art, the lenses 21 to 25 takes up only half the space required by the conventional projector. In addition, the negative third lens 23 and the positive fourth lens 24 jointly form a doublet structure, and a stop 26 is positioned between the positive second lens 22 and the negative third lens 23. Not only the size issue of the projection lens module is overcome, the above design is able to enhance image resolution, to reduce image distortion, to control the projection lens module 20's flux, and to improve image clarity. Further, the PBS 27 is positioned between the positive fifth lens 25 and the LCoS panel 28. The PBS 27 receives incident polarized light from a source light path (not shown) beneath, and reflects the polarized light towards the LCoS panel 28. The LCoS panel 28 in turn reflects the light, together with the to-be-projected image, towards the optical lenses 21˜25 through the PBS 27 which allows horizontal polarized light to pass through. Finally, the projected image is rendered on a screen by the optical lenses 21˜25.

As shown in FIG. 2, the PBS 27 is positioned between the positive fifth lens 25 and the LCoS panel 28, as described above. In addition, the positive fifth lens 25 has an area larger than that of the LCoS panel 28 behind. This follows a telecentric system design adopted by the projection lens module 20 of the present invention. The projection lens module 20 therefore has a longer back focal length. As such, there is ample space to adjust the magnification ratio by altering the distance between the lenses and the LCoS panel 28. The image of the LCoS panel 28 could still be projected precisely and without distortion to the screen with accurate proportions following the light path 29.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A projection lens module of a pico projector, comprising a plurality of lenses, a stop, a PBS (polarizing beam splitter), and an LCoS (light crystal on silicon) panel; wherein
said lenses, from outside towards inside, at least contains a negative first lens, a positive second lens attached to said negative first lens, a negative third lens, a positive fourth lens forming a doublet structure with said negative third lens, and a positive fifth lens;
said stop is positioned between said positive second lens and said negative third lens; and
said LCoS panel is positioned behind said positive fifth lens and said PBS and said positive fifth lens has an area larger than that of said LCoS panel.
